(19) United States
(12) Patent Application Publication
(10) Pub. No.: US 2005/0055429 A1
(43) Pub. Date: Mar. 10, 2005

(54) System and method for providing data and services for appliances, and appliances which use the provided data and services

(76) Inventors: Klaus Abele, Illingen (DE); Knut Lagies, Stuttgart (DE)

Correspondence Address: WHITE & CASE LLP;PATENT DEPARTMENT, 1155 AVENUE OF THE AMERICAS, NEW YORK, NY, 10036, US

(21) Appl. No.: 10/700,862

(22) Filed: Nov. 3, 2003

(30) Foreign Application Priority Data
Nov. 4, 2002 (DE) 102 51 523.9

(51) Int. Cl. G06F 15/177; G06F 15/16

(52) U.S. Cl. 709/221; 709/203

(57) ABSTRACT

A system and method for the computer-aided provision of data and/or services for appliances, comprises at least one main computer having means for storing and providing the data and/or services, and at least one appliance. The appliance includes a processing device that is connected to the main computer by means of a data communication link. The processing device includes means for executing scripts and the services can be provided by the main computer in the form of scripts.

The invention relates to a system and a method for the computer-aided provision of data and/or services via a data communication link for appliances.

The invention also relates to an appliance that uses such data and/or services provided via a data communication link.

“Client-server architectures,” which involve one or more clients being provided with data or services by a central server, have been known for a long time.

It is also known practice to use public networks (e.g., the Internet) as a transmission medium for the data and services, the data and services being transmitted from the server to the clients, or being requested from the server by a client, using “web technologies” (e.g., HTTP). In this case, the servers are powerful computer installations with a high storage capacity. The clients (requester or retriever of data and services) can be personal computers (PCs) or else appliances (e.g., peripheral appliances), for example.

An appliance can be coupled to a server (web server) over the Internet by virtue of the appliance having a browser (web browser) that is used to download web pages provided by the web server, for example.

It is also known practice to equip the appliances themselves with web servers. This means that, by way of example, a personal computer connected to the appliance over the Internet can obtain appliance data for visualization from the appliances. The drawback in this context is that this development cannot be used in existing IT infrastructures in companies or firms for security reasons (firewall problems). This is because the appliance would have to be accessed via a “firewall,” and a firewall is intended to prevent precisely such external access.

It is an object of the present invention to provide a system, a method and an appliance used by the system and method, that allow new services to be provided for the appliance even over a public network having the associated established security standards (firewalls) without changing the appliance's system software.

According to the present invention, this object is achieved for a system for the computer-aided provision of data and/or services for appliances by means of the features of claim 1. The services transferred from a main computer (server) to the appliance are defined in the form of scripts that are executed by an interpreter. One advantage of the invention is that data and services can be transferred to the appliances over a public network (Internet or public telecommunication network) and in this process a high security standard is observed. In addition, initiation of the script-controlled activities can be controlled by a user. This user-end control option for executing scripts further increases security (protection from third-party access). The inventive system allows services to be provided securely for appliances even over a public network, while maintaining security standards that are ensured in an IT infrastructure, inter alia by means of firewalls. The appliances for which the server provides data and services can be of different types: peripheral appliances (printers or other input/output appliances) or else automation appliances or industrial controllers (PLCs, NCs, CNCs, etc.) are conceivable appliances. The invention thus also includes “embedded appliances.”

A first advantageous refinement of the invention, relating to a system, involves the appliance having means for actively requesting services from the main computer. Such means can, by way of example, be Java-script or TCL interpreters that request services from the server when the need arises (when a complex service or job is executed) or upon user intervention. In this case, the appliance is in the form of a client and requests services from the server in a client-server environment. (A customer uses services; a script corresponds to a job whose execution provides a service. Scripts contain a succession of orders).

Another advantageous refinement of the invention, relating to a system, involves the appliance having reloadable intelligence. Reloadable scripts can be used to upgrade an appliance with further or additional intelligence. Alternatively, the reloadable intelligence can relate, by way of example, to operating convenience (better HMI) or can achieve better performance for services that are already available. This allows an appliance's intelligence to be extended without having to touch the appliance's system software. Maintenance work and upgrading for the appliance can therefore easily be carried out, even without physically touching the appliance. Another effect achieved by this is that the appliance need only contain the intelligence that is required for the service that is currently being used.

Another advantageous refinement of the invention, relating to a system, involves the reloadable intelligence having services and/or technology. The reloadable intelligence can be of a technological type (e.g., additional technical or technological properties), which means that it is a very simple matter to achieve technological scaling for the appliance in order to equip it for other opportunities for use.

Another advantageous refinement of the invention, relating to a system, involves the appliance containing a further processing device having means for displaying data and/or for user interaction. This allows a user to initiate services directly and to track the results of the services visually.

Another advantageous refinement of the invention, relating to a system, involves the processing apparatus and the further processing device being in the form of one device in the appliance. This allows the architecture of the appliance to be of flexible design. By way of example, the two processing devices can be implemented each in a module, or together in one common module.

Another advantageous refinement of the invention, relating to a system, involves the appliance being in the form of an interactive appliance having an input apparatus and an output apparatus. An existing human machine interface (user interface) makes it a very simple matter for a user to interact with the appliance. In particular, it allows a user to control the execution of scripts very easily. This further increases the security standard and, in particular, makes the action of the services transparent for the user (as a result of the controlled execution of the scripts). Input apparatuses are, by way of example, a keyboard and mouse, and an output apparatus can be a screen, for example.

Another advantageous refinement of the invention, relating to a system, involves the processing apparatus being connected to an industrial controller at the appliance end. The appliance itself can be an industrial controller, but it can also be connected to an industrial controller (PLC or motion controller). This allows the invention to be used very easily in the industrial field, where conversion activities (use of a new machine, manufacture of a new product, etc.) are quite often necessary. The conversion activities for the control intelligence can thus be performed on-line as a result of the invention and do not need to be carried out “physically” on the appliance.

Another advantageous refinement of the invention, relating to a system, involves the processing apparatus and/or the further processing device being integrated in an industrial controller. This increases the flexibility for the creation and use of the system or of the appliance, and design decisions can be made according to requirements.

Another advantageous refinement of the invention, relating to a system involves the appliance requesting the data and/or services on the basis of the state of the appliance or the state of the industrial controller. This means that services and maintenance services can be retrieved from the server by the appliance based on the state of the appliance or on the state of components of the appliance.

Another advantageous refinement of the invention, relating to a system, involves the data and/or services being provided under event control and/or time control. Time-controlled requisition and provision of services allow servicing and maintenance plans to be handled and carried out very easily. With event-controlled requisition and provision of services, a defined and repeatable reaction occurs when events arise.

According to the present invention, the object is achieved for an appliance for executing services that can be provided via a main computer by means of the features of claim 12. The services transferred from a main computer (server) to the appliance are defined in the form of scripts that are executed by an interpreter. One advantage of the invention is that data and services can be transferred to the appliances over a public network (Internet or public telecommunication network) and in this process a high security standard is observed. In addition, initiation of the script-controlled activities can be controlled by a user. This user-side control option for executing scripts further increases security (protection from third-party access). The inventive system allows services to be provided securely for appliances, even over a public network, while maintaining security standards that are ensured in an IT infrastructure by means of firewalls, although firewalls prevent precisely any external access to the appliance that is required for this purpose. This conflict is resolved by the invention.

The appliances for which the server provides data and services can be of different types: peripheral appliances (e.g., printers or other input/output appliances) or else automation appliances or industrial controllers (PLCs, NCs, CNCs, etc.) are conceivable appliances. The invention, however, also includes “embedded appliances.”

A first advantageous refinement of the invention, relating to an appliance, involves the appliance having means for actively requesting services from the main computer. Such means can be, by way of example, Java-script or HTML interpreters that request services from the server when the need arises (when a complex service or job is executed) or upon user intervention. In this case, the appliance is in the form of a client and requests services from the server in a client-server environment. (A customer uses services; a script corresponds to a job whose execution provides a service. Scripts contain a succession of commands).

Another advantageous refinement of the invention, relating to an appliance, involves the appliance having reloadable intelligence. Reloadable scripts can be used to upgrade an appliance with further or additional intelligence. Alternatively, the reloadable intelligence can relate, by way of example, to operating convenience (better HMI) or can achieve better performance for services that are already available. This allows an appliance's intelligence to be extended without having to touch the appliance's system software. Maintenance work and upgrading for the appliance can therefore easily be carried out, even without physically touching the appliance.

Another advantageous refinement of the invention, relating to an appliance, involves the reloadable intelligence having services and/or technology. The reloadable intelligence can be of technological type (e.g., additional technical or technological properties), which means that it is a very simple matter to achieve technological scaling for the appliance in order to equip it for other opportunities for use.

Another advantageous refinement of the invention, relating to an appliance, involves the appliance containing a further processing device having means for displaying data and/or for user interaction. This allows a user to initiate services directly and to track the results of the services visually.

Another advantageous refinement of the invention, relating to an appliance, involves the appliance being in the form of an interactive appliance having an input apparatus and an output apparatus. An existing human machine interface (HMI) makes it a very simple matter for a user to interact with the appliance. In particular, it allows a user to control the execution of scripts very easily. This further increases the security standard and, in particular, makes the action of the services transparent for the user (as a result of the controlled execution of the scripts). Input apparatuses are, by way of example, a keyboard and mouse, and an output apparatus can be a screen, for example.

Another advantageous refinement of the invention, relating to an appliance, involves the processing apparatus and the further processing device being in the form of one device. This allows the architecture of the appliance to be of a flexible design. By way of example, the two processing devices can be implemented each in a module or together in one common module.

Another advantageous refinement of the invention, relating to an appliance, involves the processing apparatus being connected to an industrial controller or being integrated in the industrial controller. The appliance itself can be an industrial controller, but it can also be connected to an industrial controller (PLC or motion controller). This allows the invention to be used very easily in the industrial field, where conversion activities (use of a new machine, manufacture of a new product, etc.) are quite often necessary. The conversion activities for the control intelligence can thus be performed on-line as a result of the invention and do not need to be carried out “physically” on the appliance.

Another advantageous refinement of the invention, relating to an appliance, involves the data and/or services being requested on the basis of the state of the appliance or the state of the industrial controller. This means that servicing and maintenance services can be retrieved from the server by the appliance based on the state of the appliance or on the state of components of the appliance.

Another advantageous refinement of the invention, relating to an appliance, involves the data and/or services being provided under event control and/or time control. Time-controlled requisition and provision of services allow servicing and maintenance plans to be handled and carried out very easily. With event-controlled requisition and provision of services, there is a defined and repeatable reaction when events arise.

In accordance with the present invention, the object is achieved for a method for the computer-aided provision and/or execution of data and/or services by means of the features of claim 22. The services transferred from a main computer (server) to the appliance are defined in the form of scripts which are executed by interpreters. One advantage of the invention is that data and services can be transferred to the appliances over a public network (Internet or public telecommunication network) and in this process a high security standard is observed. If the appliance is in the form of an “interactive client,” i.e. the appliance can interact with a user, then initiation of the script-controlled activities can be controlled by a user. This user-side control option for executing scripts further increases security (protection from third-party access).

A first advantageous refinement of the invention, relating to a method, involves the service containing a unique identifier for the appliance. This allows a service to be executed in the first place, because without this unique appliance identifier the server would not know for which appliance the service needs to be provided. In addition, this identifier is important in order to be able to bill a specific appliance for a service.

A first advantageous refinement of the invention, relating to a method, involves the appliance having reloadable intelligence for the services. Reloadable scripts can be used to upgrade an appliance with further or additional intelligence. The reloadable intelligence can be of a technological type (e.g., additional technical or technological properties), which means that it is a very simple matter to achieve technological scaling for the appliance in order to equip it for other opportunities for use. Alternatively, the reloadable intelligence can, by way of example, relate to the operating convenience (better HMI) or can achieve better performance for services that are already available.

Another advantageous refinement of the invention, relating to a method, involves a service being requested by an interactive appliance having a user interface. An existing human machine interface (HMI) makes it a very simple matter for a user to interact with the appliance. In particular, it allows a user to control the execution of scripts very easily. This further increases the standard of security and, in particular, makes the action of the services transparent for the user (as a result of the controlled execution of the scripts).

Another advantageous refinement of the invention, relating to a method, involves the processing device reporting the execution of a service to a further processing device. This means that the further processing device can send a corresponding request to the server, which can use said request, by way of example, to display the results on an output unit (e.g., screen).

Another advantageous refinement of the invention, relating to a method, involves the services being defined by script languages and the processing device and the further processing device containing means for executing the scripts. A script describes sequences of action that are executed “instruction by instruction” by an appropriate interpreter. The use of script languages means that it is possible to program interactions between applications very easily. In addition, the use of script languages makes it a very simple matter for a user to make individual adjustments to the applications. Known script languages are Visual Basic Script and Java script. Opening a script file starts the associated interpreter and executes the script program. An interpreter analyzes a source program (available in a script file in the script language) instruction by instruction and immediately executes an analyzed instruction using a runtime system. In this context, an interpreter breaks down the source language instructions into their elementary components step by step, checks their syntax and executes target language instructions directly for each component. Due to the direct execution, an interpreter also needs, besides the source program, the associated data. An advantage of using script languages and an interpreter is the flexibility, simplicity and speed of interactive program and service creation.

Another advantageous refinement of the invention, relating to a method, involves the data and/or services being requested on the basis of the state of the appliance. This means that the appliance can take the state of the appliance or can take the state of components of the appliance as a basis for retrieving servicing and maintenance services from the server.

Another advantageous refinement of the invention, relating to a method, involves the data and/or services being provided under event control and/or time control. Time-controlled requisition and provision of services allow servicing and maintenance plans to be handled and carried out very easily. Event-controlled requisition and provision of services mean that there is a defined and repeatable reaction when events arise.

Another advantageous refinement of the present invention, for use in a system in accordance with the invention, or for use in a method in accordance with the invention, involves a service being able to be divided into one or more server components and/or one or more client components. This allows execution of the service to be matched efficiently to the respective underlying request and infrastructure.

Another advantageous refinement of the present invention, for use in a system in accordance with the invention or for use in a method in accordance with the invention, involves the service containing a unique identifier for the appliance. This allows a service to be executed in the first place, because without this unique appliance identifier the server would not know for which appliance the service needs to be provided. In addition, this identifier is important in order to be able to bill a specific appliance for a service.

Another advantageous refinement of the present invention, for use in a system in accordance with the invention or for use in a method in accordance with the invention, involves the server components of the service being executed on at least one main computer, and the client components of the service being executed on at least one appliance. This means that time-critical parts of a service (e.g., queries) can be resident on the client, and those parts of a service that are intensive in terms of computation, storage space and resources are resident on the server. Normally, a server also provides a complex infrastructure, such as a link to an SMS provider. An appliance having such an infrastructure and a large amount of storage space and processor power would be expensive. An appliance naturally always needs to be active independently in order to request a service from the server.

A server is regarded as a service provider. In this function, it can also be a plurality of servers or computers having server functionality. That is to say, a server can also be in the form of an association of servers.

Other advantages and details of the invention will be revealed in the description of advantageous exemplary embodiments which now follows and in conjunction with the figures. Where different figures describe elements having identical functionalities, these elements have been distinguished using identical reference symbols.

In the figures:

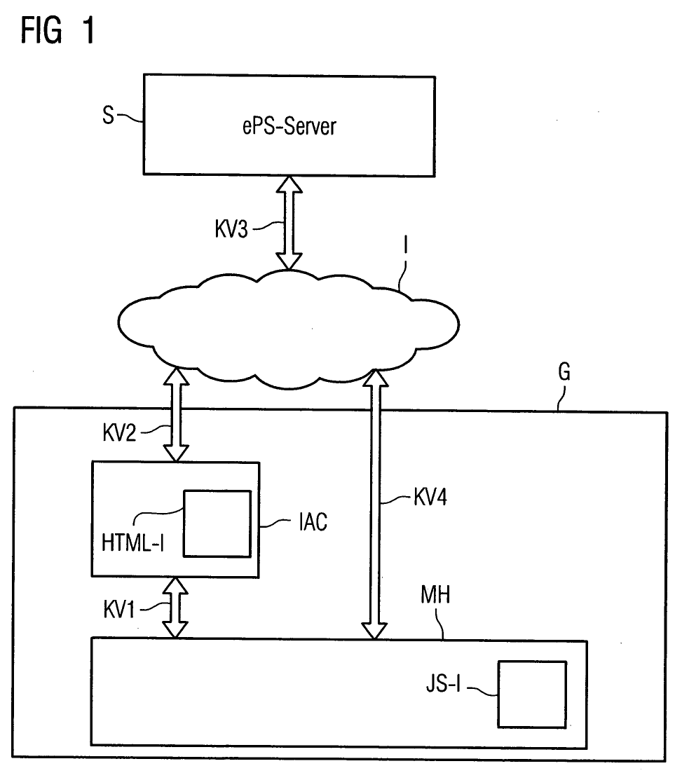

FIG. 1 shows a schematic illustration of the inventive system;

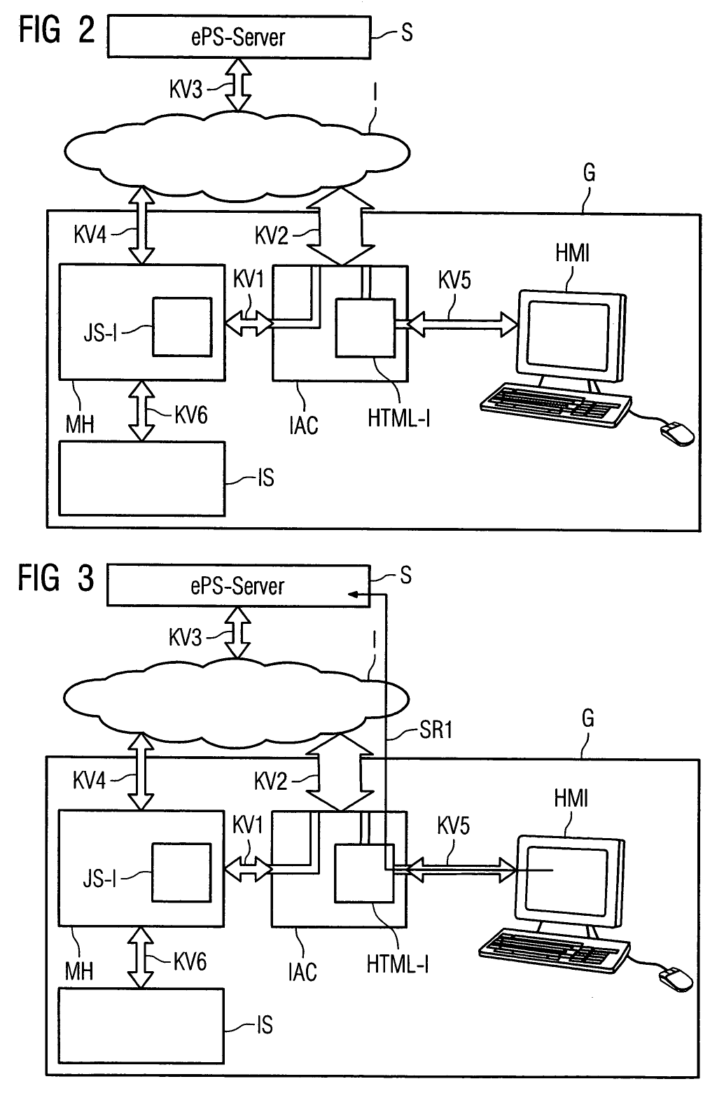

FIGS. 2-11 show a scenario for the use of the inventive system, method and appliance.

The illustration shown in FIG. 1 shows a schematic illustration of the inventive system. The system comprises a main computer S, denoted ePS™ server in FIG. 1, and an appliance G which contains a processing device MH and a further processing device IAC. The processing device MH is connected to the further processing device IAC by means of the communication link KV1. The main computer S is connected to the appliance G by means of a public communication network I. Such a public network can be, by way of example, the Internet or another public communication network. However, it is also conceivable for the main computer S to be connected to the appliance by means of an in-house network (e.g., intranet or LAN). The communication links KV2, KV3 and KV4 show how the main computer (server) S, the processing device MH and the further processing device IAC are connected to the public network.

The appliance G can be in the form of an “interactive client,” i.e. provided with input and output units, so that a user can control the execution of the scripts through inputs.

The present invention allows appliances, particularly embedded appliances, to be provided with services by other computers S over a public network I, with the technical properties (data, functions) of these appliances being used. The invention proposed makes it possible to use the processing device (machine handler) MH to load scripts from the main computer (server) S and to execute them on the appliance, with access to data and functions being made possible with appliances of local intelligence. If the connection medium used between the main computer (server) S and the appliance G is a public network I, then there is the risk of insufficient security, i.e., that unauthorized third parties will intervene in a manipulative manner. The inventive system architecture now allows a public network I to be used as the connection medium between the main computer S and the appliance G and in so doing makes it possible to ensure sufficient security. The further processing device IAC allows a user to use suitable input tools (e.g., keyboard, mouse etc.) to control the initiation of such script-controlled activities, which do not permit external access due to the security architecture with respect to public networks. With an appropriate configuration, the processing device (machine handler) MH can also request new services or jobs (in the form of scripts) from the main computer (server) S automatically at particular intervals or when initiated by events. It is also conceivable for the processing device (machine handler) MH to inform the further processing device IAC about the end of its activities for a particular task. This means that the further processing device IAC can send a corresponding request to the main computer (server) S, which can in turn use this request, by way of example, to display results on the user interface.

The main computer (server, ePS™ server) S can send data and services to the appliance G over the public network I. Such services can be new services or jobs requested by the appliance, for example. These jobs are loaded onto the appliance G in the form of scripts. The appliance G has means JS-I and HTML-I for interpreting and executing these scripts. FIG. 1 shows that the processing device (machine handler) MH contains an HTML interpreter HTML-I and that the further processing device IAC contains a Java script interpreter JS-I.

The inventive appliance can be, by way of example, a peripheral appliance (printer or output unit). It will usually be in the form of an embedded appliance, however. In the area of industrial automation technology, and particularly in the field of numerically controlled machine tools, manufacturers offer servicing in the form of control technology and corresponding software components or embedded appliances G for other manufacturers of original accessories (“original equipment manufacturers” OEMs) which manufacturer and market industrial machine tools. The present invention can be used to provide an end customer who has purchased a machine, for example, from an OEM with services and machine-related know-how for embedded appliances contained in the purchased machine. This allows a significant improvement in the availability of the machines, their useful life and their productivity, for example. In addition, the present invention ensures that these services and the know-how can be transferred to the appliance over a public network under a high standard of security.

The processing devices MH and IAC can be in the form of separate modules, but can also be integrated in one module. In addition, the processing device (machine handler) MH can be coupled to an industrial controller IS (PLC or motion control), but it is also possible for the processing device (machine handler) MH to be integrated in an industrial controller IS or in another appliance.

The illustrations shown in FIG. 2 to FIG. 11 show a scenario for the use of the inventive system, method and appliance. The illustration shown in FIG. 2 shows how the main computer (ePS™ server) S is connected to an interactive appliance G by means of a public network (Internet) I. The main computer S is connected to the public network I by means of the communication link KV3. At the appliance end, the processing device (machine handler) MH and the further processing device IAC are connected to the public network I by means of the communication links KV4 and KV2. The further processing device IAC is connected to an HMI (control device with input and output means) by means of the communication link KV5. A user can use this user interface HMI to interact with the appliance and, in so doing, control the execution of scripts. The communication link KV1 connects the further processing device IAC to the processing device MH. The communication link KV6 connects the processing device (machine handler) MH to a further appliance IS. This further appliance IS can be, by way of example, an industrial controller or another peripheral appliance. The communication link KV2 is normally used to transport web pages (preferably in HTML or another markup language). Web pages from the main computer (ePS™ server) S to the further processing device IAC usually also contain commands for the further processing device IAC. The communication link KV4 is usually used to transport Java script code.

The steps in a scenario which are described in FIG. 2 to FIG. 11 are shown by means of arrows SR1-SR9.

FIG. 3 shows the first step in the scenario using the arrow SR1: the further processing device IAC calls up a web page with a function on the main computer (ePS™ server) S.

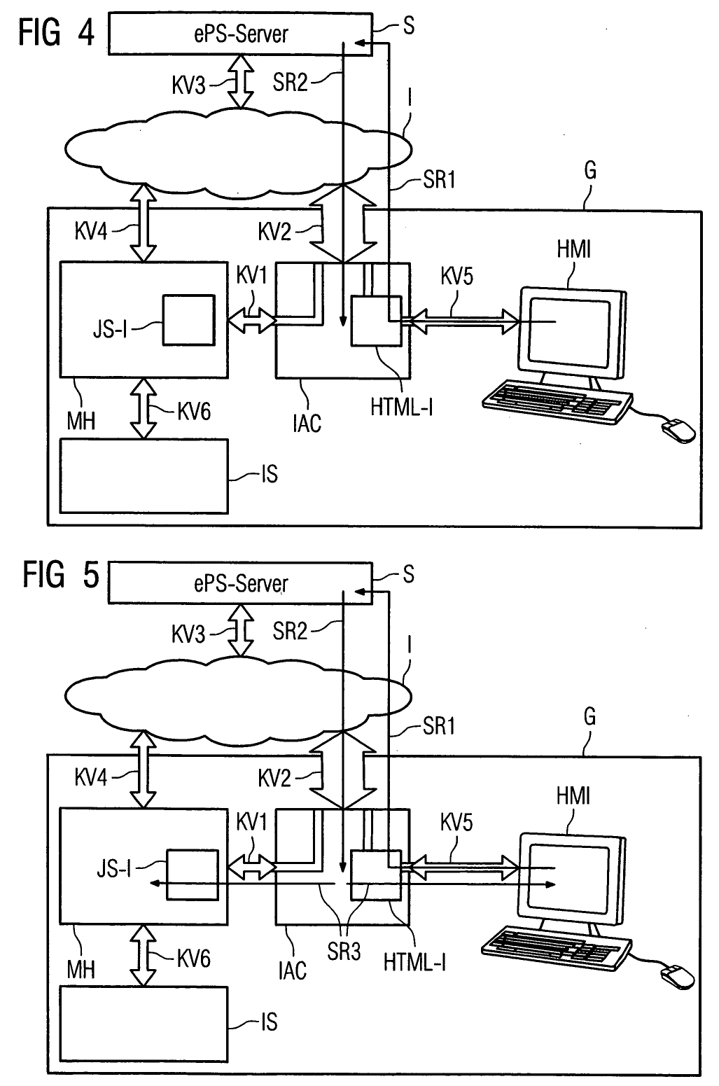

FIG. 4 shows the second step in the scenario, shown by the arrow SR2: the main computer (ePS™ server, web server) S responds with a web page that contains a command to the processing device (machine handler) MH. The web server S produces a job with job IDs and waits for a job request by the further processing device IAC. The web server S thus waits for a request from the further processing device IAC that the appliance G, as client, uses to request the job, which represents a service.

FIG. 5 uses the two arrows SR3 to show the third step in the scenario: the arrow SR3 pointing to the right shows that the web page in HTML format goes to the interpreter HTML-I and hence to the displayed HMI. The arrow SR3 pointing to the left shows that a command is sent to the processing device (machine handler) MH asking that the job provided in the web server S be requested.

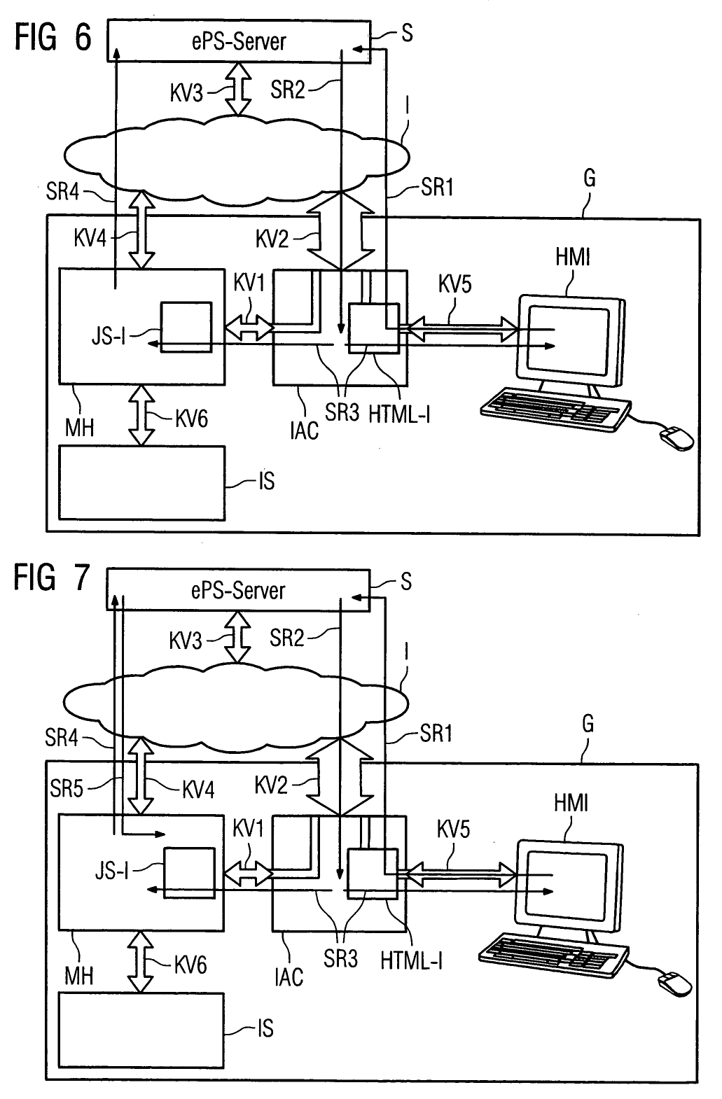

FIG. 6 uses the arrow SR4 to show the fourth step in the scenario: the processing device (machine handler) MH requests from the web server S the provided job using a machine ID (unique appliance identifier) and a job ID. The job ID uniquely identifies the job (service provided), and the machine ID uniquely identifies the appliance.

FIG. 7 uses the arrow SR5 to show the fifth step in the scenario: the web server S loads the job (service) onto the processing device (machine handler) MH, and this processing device executes the job (service). Execution is effected by the Java script interpreter JS-I.

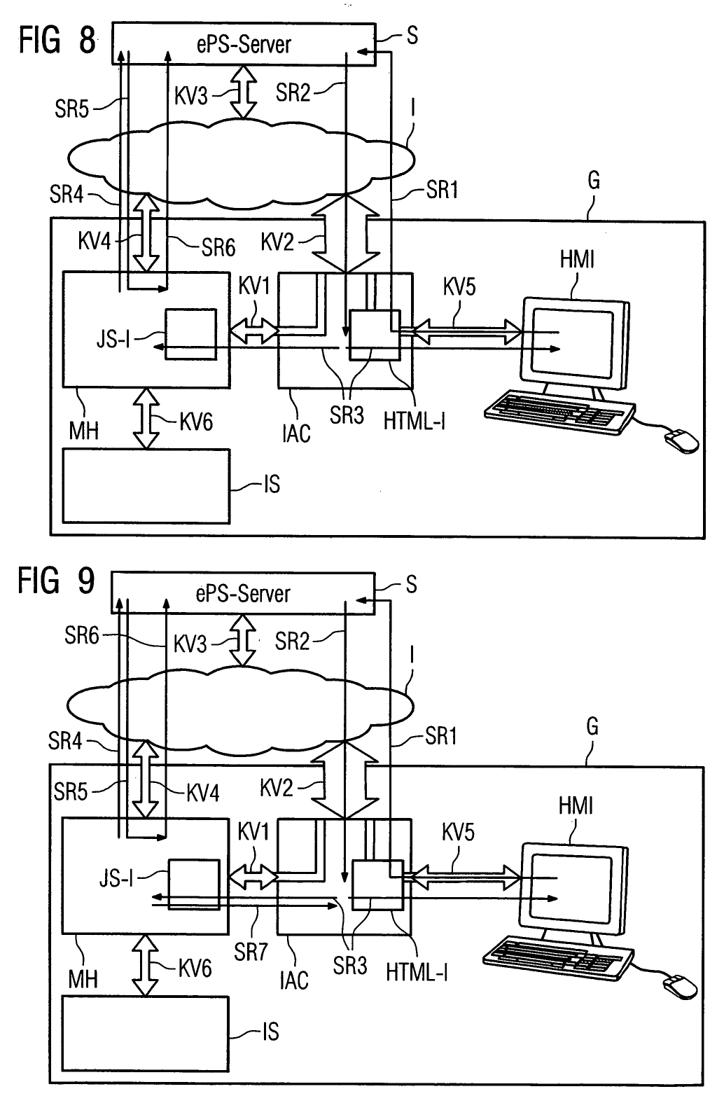

FIG. 8 uses the arrow SR6 to show the sixth step in the scenario: depending on how the job is configured and what tasks it needs to perform, it loads data, status information and error messages for the web server S.

FIG. 9 uses the arrow SR7 to show the seventh step in the scenario: the processing device (machine handler) MH reports to the further processing device IAC that the job has ended.

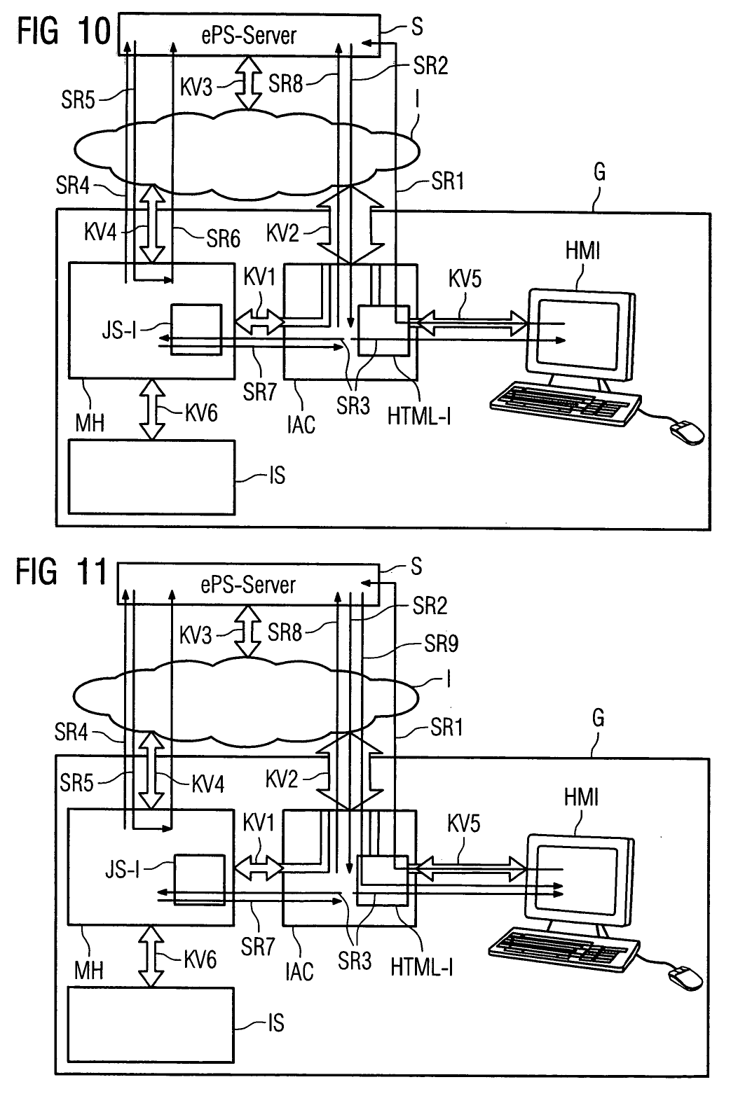

FIG. 10 uses the arrow SR8 to show the eighth step in the scenario: the further processing device IAC requests the next web page from the web server S.

FIG. 11 uses the arrow SR9 to show the ninth step in the scenario: the web server S sends a new web page to the further processing device IAC, for example with the results of the job which has been performed. These results are displayed on the user interface HMI. By way of example, a popular web browser (standard browser) can be used for the purposes of display.

The main computer (ePS™ server) S is usually in the form of a web server, or it contains a web server with the functionality that is customary for a web server, namely storage and provision of web pages in a format that is customary for use of the Internet (e.g., HTML or another markup language, such as XML). The services or jobs can also be executed under time control, cyclically or on the basis of the state of the appliance or on the basis of the state of a connected further appliance, such as an industrial controller IS. A server usually has a large disk capacity or processor power, and provides infrastructure services (e.g., linking to SMS or email providers) for the clients.

The appliance can be in the form of an interactive appliance, i.e. with a user interface HMI, but can also do without a user interface HMI.

The following fundamental advantages are obtained from the invention: appliances can be provided with services over a public network (e.g., the Internet), because the inventive solution is compatible with the level of security technology. Another advantage is that, if new services are developed, these can be used just by using reloadable scripts relating to the appliance, without changing the appliance's system software. In addition, the interaction with a user for a given service (job) can be dealt with by means of the interaction between processing device (machine handler) MH and further processing device IAC.

Another advantage is that the appliance can be kept “small,” since those components of the services that use up resources (storage space, processor power) are executed on the server. This is an advantage over appliances or controllers that have integrated web servers.

The present invention allows appliances to be in the form of “thin clients.” This has the advantage that the appliances require less hardware, less storage space, less computing power and less space. This results in a cost advantage.

All activities originate in the appliance, either when initiated by the user or when initiated by software blocks (modules) that perform polling on the server.

Typical services requested from the server S by an appliance G are, by way of example, the sending of emails or SMSs to people when alarm events occur, the storage of state information on the server S in the case of an error in the appliance G, the storage of archive data and configuration data from the appliance on the server, or the automation of SW installation on the appliance (Install Shield®, as is known for PCs).

The configuration of the inventive system and the architecture of the inventive appliance allow secure communication with appliances. That is, a high security standard is made possible even when using a public network (e.g., the Internet) as a communications medium. In existing IT infrastructures, the firewalls that are normally used completely preclude any external access to appliances, or make it very difficult and involved, since it is first necessary to overcome the firewalls. A firewall is intended to prevent such external access, of course.

The execution scenario described in FIGS. 2-11 can also be regarded as a protocol for the aforementioned secure communication.

The inventive appliance is used primarily as a client, but it is also conceivable for the appliance to have server functionality.

1-32. (canceled)

33. A system for computer-aided provision of at least one of the group consisting of data and services for appliances, comprising:
at least one main computer having means for storing and providing the data, services, or both; and
at least one appliance having a processing device connected to the main computer by means of a data communication link, wherein the processing device comprises means for executing scripts and wherein the services are provided by the main computer in a form comprising scripts.

34. The system according to claim 33, wherein the appliance comprises means for actively requesting services from the main computer.

35. The system according to claim 33, wherein the appliance comprises reloadable intelligence.

36. The system according to claim 35, wherein the reloadable intelligence comprises at least one of the group consisting of services and technology.

37. The system according to claim 33, wherein the appliance comprises a further processing device having means for displaying data.

38. The system according to claim 33, wherein the appliance comprises a further processing device having means for user interaction.

39. The system according to claim 37, wherein the processing device and the further processing device together form a single device in the appliance.

40. The system according to claim 33, wherein, the appliance is in the form of an interactive appliance having an input apparatus and an output apparatus.

41. The system according to claim 33, wherein the processing device is coupled to an industrial controller.

42. The system according to claim 37, wherein at least one of the processing device and the further processing device are integrated in an industrial controller.

43. The system according to claim 41, wherein the appliance requests the data, the services, or both, on the basis of the state of at least one of the appliance and the industrial controller.

44. The system according to claim 33, wherein at least one of the data and the services is provided under at least one of the group consisting of event control and time control.

45. An appliance for executing services provided via a main computer, comprising:
a processing device coupled to the main computer by means of a data communication link, the processing device comprising means for executing scripts, and the services provided by the main computer in the form of scripts.

46. The appliance according to claim 45, wherein the appliance has means for actively requesting services from the main computer.

47. The appliance according to claim 45, wherein the appliance comprises reloadable intelligence.

48. The appliance according to claim 47, wherein the reloadable intelligence selected from the group consisting of services and technology.

49. The appliance according to claim 45, wherein the appliance comprises a further processing device having means for displaying data.

50. The appliance according to claim 45, wherein the appliance comprises a further processing device having means for user interaction.

51. The appliance according to claim 45, wherein the appliance comprises an interactive appliance having an input apparatus and an output apparatus.

52. The appliance according to claim 45, wherein the processing device and the further processing device together form a single device.

53. The appliance according to claim 45, wherein the processing device is coupled to an industrial controller.

54. The appliance according to claim 45, wherein the processing device is integrated in an industrial controller.

55. The appliance according to claim 45, wherein the services are requested on the basis of at least one of the group consisting of the state of the appliance and the state of the industrial controller.

56. The appliance according to claim 45, wherein the services are provided under at least one of the group consisting of event control and time control.

57. A method for the computer-aided provision of services for execution by an appliance, where a first processing device associated with the appliance is in communication via data communication links with a main computer and a second processing device, the method comprising the steps of:
the appliance makes a request to the main computer for the provision of data;
the main computer sends the second processing device data which the second processing device analyzes and forwards to at least one of the first processing device and a user terminal;
the first processing device analyzes the received data and requests corresponding services from the main computer on the basis of these data;
the main computer loads the services onto the processing device;
the processing device executes the services; and
the services load at least one of the group consisting of data, status information, and error messages to the main computer.

58. The method according to claim 57, wherein the service is associated with a unique identifier for the appliance.

59. The method as claimed in claim 57, wherein the appliance comprises reloadable intelligence for the services.

60. The method according to claims 57, wherein the appliance is interactive and comprises a user interface.

61. The method according to claim 57, wherein the first processing device reports execution of a service to the second processing device.

62. The method according to claim 57, wherein the services are defined by script languages, and the first processing device and the second processing device comprise means for executing the scripts.

63. The method according to claim 57, wherein the appliance is characterized by a state and the services are requested on the basis of the state of the appliance.

64. The method according to claim 57, wherein the services are provided under at least one of event control and time control.

65. A service for use in a system for computer-aided provision of at least one of the group consisting of data and services for appliances, the system comprising at least one main computer having means for storing and providing the data, services, or both and further comprising at least one appliance having a processing device connected to the main computer by means of a data communication link, wherein the processing device comprises means for executing scripts and wherein the services are provided by the main computer in a form comprising scripts, the service for use in a method as claimed in claim 25 and comprising either or both of at least one server component and at least one client component.

66. The service according to claim 57, wherein the service is associated with a unique identifier for the appliance.

67. The service according to claim 65, wherein server components of the service are executed on at least one main computer, and client components of the service are executed on at least one appliance.

68. A service for use in a method according to claim 57, wherein the service comprise at least one of a server component and a client component.

69. The service according to claim 68, wherein the service is associated with a unique identifier for the appliance.

70. The service according to claim 68, wherein server components of the service are executed on at least one main computer, and client components of the service are executed on at least one appliance.
